(19) United States
(12) Patent Application Publication
(10) Pub. No.: US 2005/0249519 A1
(43) Pub. Date: Nov. 10, 2005

(54) Cartridge for toner having removable seal

(75) Inventor: Clayton Chadez, Nampa, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: REC & Assign

(21) Appl. No.: 10/840,150

(22) Filed: May 6, 2004

(51) Int. Cl. G03G 15/08

(52) U.S. Cl. 399/106

(57) ABSTRACT

Apparatus and methods to ensure that a seal has been removed from a toner cartridge before the cartridge is installed in an imaging device are described. In one implementation a cartridge configured to contain toner which is to be consumed by an imaging device via an outlet opening in the cartridge is described. The cartridge includes a reservoir configured to contain the toner. The reservoir is coupled in fluid flowing relation to the outlet opening. A removable seal is releasably coupled to the cartridge. The seal is configured to substantially seal the outlet opening while the seal is coupled to the cartridge. A pull-ring is attached to the seal. The pull-ring is configured to prevent installation of the cartridge into the imaging device while the seal is coupled to the cartridge.

### BACKGROUND

A wide variety of imaging devices are used to produce printed materials. Many such imaging devices include a cartridge which is configured to contain a consumable such as toner. The toner is typically contained within a reservoir inside the cartridge. The toner is held within the reservoir until it is supplied to the imaging device where it is consumed as images are formed on an imaging media. More specifically, as images are formed by the imaging device, the toner from the cartridge is applied to a print media such as paper via an electrostatic process. As these images are formed by the imaging device the toner is consumed.

Because the toner is used-up (i.e., consumed) by the imaging device as images are formed, the depleted cartridge must be periodically replaced with a fresh cartridge which provides a new supply of the toner for use by the imaging device.

Before being installed in an imaging device, the fresh cartridge (i.e., the cartridge containing a new supply of the toner) typically includes at least one seal which must be removed before the cartridge is ready for use. Such seals are typically provided by cartridge manufacturers in order to prevent the toner contained within the cartridge from being lost or otherwise depleted during storage and/or shipping. If the fresh cartridge is installed in the imaging device without removing the seal, the toner will typically be trapped inside the cartridge, and the imaging device will not function properly.

Therefore, when installing a fresh cartridge in an imaging device, it is important that any such seal be removed prior to installation. Removal of the seal typically allows the toner to move from the cartridge to the imaging device, so that the toner can be used to form images.

Unfortunately, it is common for users to install a fresh cartridge in an imaging device without first removing the seal. This may happen because the user is unaware that the fresh cartridge includes the seal which should have been removed, or because the user simply forgets to remove the seal. In either case, the imaging device will not function properly after the fresh cartridge has been installed. This can result in unnecessary calls to a customer help desk, and/or unnecessary service calls with their associated expenses. In any case, a failure to remove the seal will at the very least delay the user's ability to use the imaging device until the problem has been corrected.

In an effort to avoid such costs and delays, some imaging devices now include sensors which are designed to determine whether the seal has been properly removed when a fresh cartridge is installed. Although the use of such sensors can be helpful in assuring that the seal has been properly removed, the expenses associated with adding such sensors to imaging devices can be significant. It is desirable to develop methods and apparatus which will ensure that the seal is removed when a fresh cartridge containing toner is installed in an imaging device, and which will accomplish the desired results efficiently while minimizing the associated expenses.

### SUMMARY

Cartridges for containing toner, imaging devices for receiving cartridges containing toner, and methods for ensuring that a seal is removed when a cartridge containing toner is installed in an imaging device are described. The embodiments disclosed herein are for illustrative purposes and should not be construed as limiting the invention.

In one aspect a cartridge is described. The cartridge is configured to contain toner which is to be consumed by an imaging device via an outlet opening in the cartridge. The cartridge includes a reservoir configured to contain the toner. The reservoir is coupled in fluid flowing relation to the outlet opening. A removable seal is configured to be releasably coupled to the cartridge, and is further configured to substantially seal the outlet opening while the seal is coupled to the cartridge. A pull-ring is coupled to the removable seal, and is configured to prevent installation of the cartridge into the imaging device while the seal is coupled to the cartridge.

In another aspect an imaging device is described. The imaging device includes a receptacle configured to receive a cartridge containing toner. The receptacle is at least partially defined by a blocking surface which in operation prevents the cartridge from being received by the receptacle until a seal assembly has been removed from the cartridge.

In yet another aspect a method to ensure that a seal is removed from a cartridge configured to contain toner before the cartridge is installed in an imaging device is described. The method includes providing the cartridge which is configured to be received within a designated receptacle within the imaging device. The method also includes providing the seal, which is releasably coupled to the cartridge, and providing a pull-ring which is coupled to the seal. The pull-ring is configured to prevent the cartridge from being received within the designated receptacle until the seal has been uncoupled from the cartridge.

### DESCRIPTION OF THE DRAWINGS

FIG. 1 is a perspective view showing a cartridge configured to contain toner to be consumed by an imaging device in accordance with one embodiment of the present invention.

FIG. 2 is simplified cross sectional view showing the cartridge of FIG. 1.

FIG. 3 is a perspective view showing the cartridge of FIG. 1, and an imaging device in accordance with another aspect of the present invention.

FIG. 4 is a perspective view showing the cartridge of FIG. 1, and a user preparing to remove the seal from the cartridge.

FIG. 5 is a perspective view showing the cartridge of FIG. 1, and a user removing the seal from the cartridge.

FIG. 6 is a perspective view showing the cartridge of FIG. 1, and a user having removed the seal from the cartridge.

FIG. 7 is a perspective view showing the cartridge of FIG. 1, and an imaging device in accordance with another aspect of the present invention.

FIG. 8 is a perspective view showing the cartridge of FIG. 1, and the imaging device of FIG. 7 in accordance with another aspect of the present invention.

### DETAILED DESCRIPTION

A wide variety of imaging devices can be used to produce images on an imaging media. Many such imaging devices include a cartridge which is configured to contain and provide toner for use by the imaging device. The toner provided by the cartridge is then consumed by the imaging device as images are formed on an imaging media. Because the toner is used-up (i.e., consumed) by the imaging device as images are formed, the depleted cartridge must periodically be replaced with a fresh cartridge, thereby providing a fresh supply of the toner for use by the imaging device.

In the context of this document, the term “imaging device” refers to any apparatus which uses toner to generate an image on an imaging media, such as paper or the like. Examples of imaging devices include, without by way of limitation, printers, copiers, facsimile machines, and other devices which use toner from a cartridge to apply an image onto imaging media. The term “toner” refers to any powder used in an electrostatic process to form an image, and is also broadly used herein to refer to any material other than ink which can be contained within a cartridge and used by an imaging device to form images.

Before being installed in the imaging device, the fresh cartridge will typically include at least one seal which is to be removed before the cartridge is ready for use. Such seals are typically provided by cartridge manufacturers in order to prevent the toner contained therein from being lost or otherwise depleted during storage and/or shipping of the cartridge. If a fresh cartridge is installed in an imaging device without removing the seal, the toner will typically be trapped inside the cartridge, and the imaging device will not function properly.

Therefore, before installing a fresh cartridge in an imaging device, it is important that any such seal be removed. Removal of the seal typically allows the toner to flow or otherwise move from the cartridge to the imaging device, so that the toner can be used to form images. In an effort to facilitate the remove such seals, companies which manufacture cartridges can include a small tab which is somehow attached to the seal which is to be removed. This tab can be grasped by the user to facilitate removal of the seal. Typically, before installing the fresh cartridge, the user will grasp the tab and pull so that the entire length of the seal (e.g., flexible seal tape) is removed from the cartridge. Once the seal has been completely removed from the fresh cartridge, the fresh cartridge is ready to be installed and used in the imaging device. Removal of the seal tape allows the toner to flow or otherwise move from the cartridge to the imaging device as needed.

As described above, it is desirable to develop cartridges for containing toner, imaging devices for receiving cartridges containing toner, and methods which ensure that such seals are removed before fresh cartridges containing toner are installed in the imaging devices. Moreover, it is desirable to develop methods and apparatus which will accomplish these objectives in a convenient and efficient manner. It is also desirable that such methods and apparatus accomplish these goals without the need for additional sensors. While the present invention is principally directed towards overcoming the above identified issues, the invention is in no way so limited, and is only limited by the accompanying claims as literally worded and appropriately interpreted in accordance with the Doctrine of Equivalents.

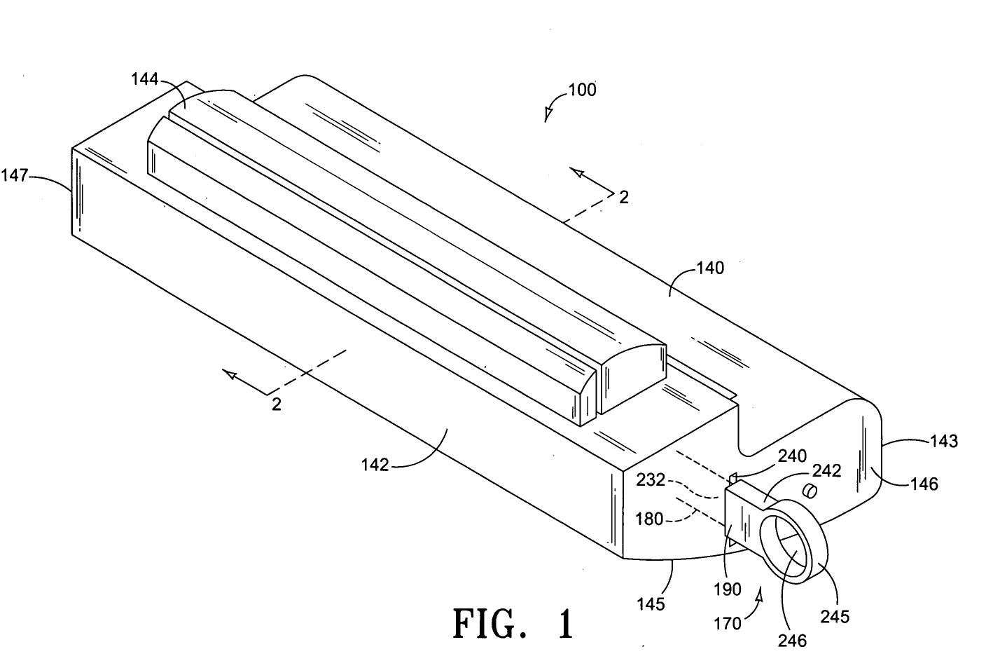

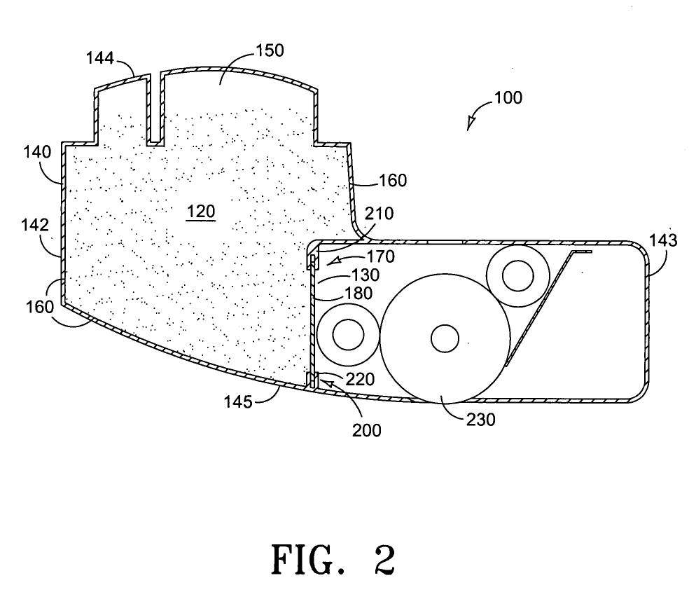

Referring generally to FIGS. 1-8, a cartridge 100 for containing toner is shown either in isolation, or is shown being inserted into and imaging device 110. FIG. 1 shows the cartridge 100 in a perspective view, while FIG. 2 provides a cross sectional view of the cartridge 100 of FIG. 1. The cartridge 100 is configured to contain toner 120, which is to be consumed by the imaging device 110 as images are formed. The toner 120 which is contained in the cartridge 100 is to be consumed by the imaging device 110 via an outlet opening 130 in the cartridge 100 as described in detail below.

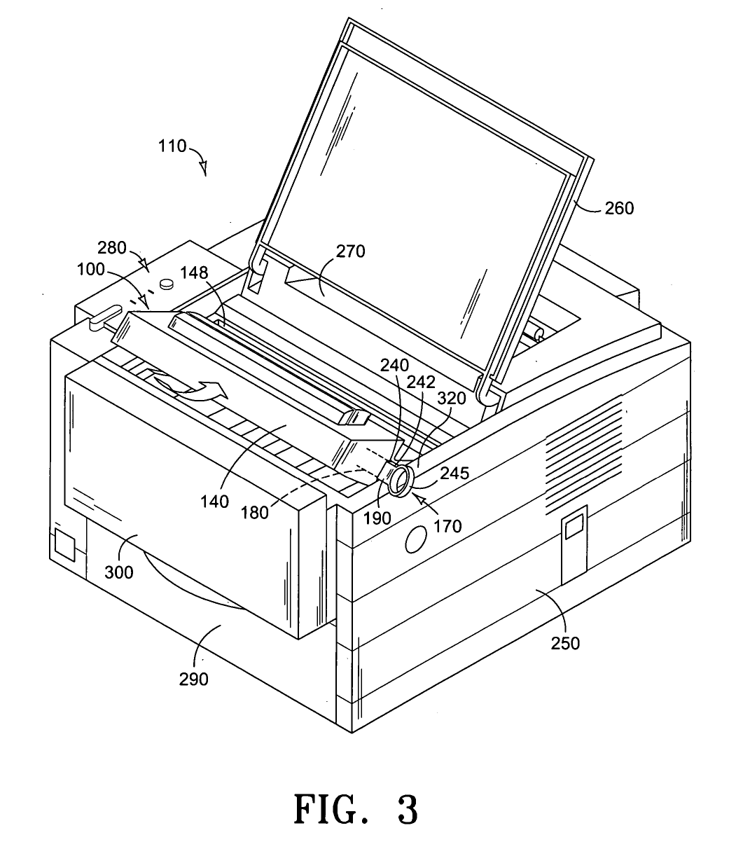

The cartridge 100 includes an external cartridge housing 140. As shown in FIGS. 1-2, the cartridge housing 140 includes a front wall 142, a rear wall 143, an upper wall 144, a lower wall 145, a first side wall 146, and a second side wall 147. The cartridge 100 is defined at least in part by the cartridge housing 140 which determines the general overall shape of the cartridge 100. The cartridge housing 140 typically defines a shape which is configured to be received within a designated receptacle 148 within the imaging device 110 (see FIGS. 3, 7 and 8).

As best shown in FIG. 2, the cartridge housing 140 also encloses a reservoir 150 which is configured to contain the toner 120. In FIG. 2, the toner 120 is shown (as stippling) to fill the lower portion of the reservoir 150. The reservoir 150 is defined in part by a reservoir wall 160. The outlet opening 130 is formed through at least one portion of the reservoir wall 160, and provides a path through which toner 120 can flow or otherwise move as it exits the reservoir 150 to be used by the imaging device 110. Thus, the reservoir 150 is coupled in fluid flowing relation to the outlet opening 130, to thereby supply the toner 120 which is to be used by the imaging device 110. It should be noted that the term “coupled in fluid flowing relation” is used herein to describe the coupling present between the reservoir 150 and the outlet opening 130, which allows the toner 120 to flow or otherwise move from the reservoir 150 through the outlet opening 130 to be consumed by the imaging device 110.

Referring now to FIGS. 1-6, the cartridge 100 is shown to include a removable seal assembly 170. The removable seal assembly 170 includes a removable seal 180 and a pull-ring 190 which is attached to the removable seal 180. The removable seal 180 is configured to be releasably coupled to the cartridge 100. In addition, the removable seal 180 is configured to substantially seal the outlet opening 130 while the seal is coupled to the cartridge 100. When the removable seal 180 is uncoupled from the cartridge 100, the outlet opening 130 is no longer substantially sealed, and toner 120 can move through the outlet opening 130 as needed.

The removable seal 180 can be of any suitable configuration, so long at the seal 180 is configured to substantially seal the outlet opening 130 while the seal 180 is coupled to the cartridge 100. In one implementation, shown in FIGS. 1-6, the removable seal 180 is provided as a flexible tape. Therefore, in this document, the numeral 180 can also be used to refer to the flexible tape (i.e., one implementation of the removable seal). The flexible tape 180 is releasably coupled to the cartridge 100, and is configured to substantially seal the outlet opening 130 while the flexible tape 180 is coupled to the cartridge 100.

Referring now primarily to FIG. 2, the flexible tape 180 it configured so that is can be positioned within a grove or slot 200 inside the cartridge 100. While the flexible tape 180 is coupled to the cartridge 100 to substantially seal the outlet opening 130, the flexible tape 180 is positioned within the slot 200. The slot 200 can include an upper track 210 and a lower track 220 which generally define the slot 200. The slot 200 can extent substantially along the length of the cartridge 100. When the flexible tape 180 is coupled to the cartridge 100, the flexible tape 180 is positioned within the slot 200, so that the flexible tape 180 is held in place within these upper and lower tracks 210 and 220. When coupled to the cartridge 100 in this way, the flexible tape 180 substantially seals the outlet opening 130, thereby blocking all or most of the flow or movement of toner 120 through the outlet opening 130. This is but one example of how the removable seal 180 can be configured to substantially seal the outlet opening 130 while the seal 180 is coupled to the cartridge 100.

When the flexible tape 180 has been uncoupled or removed from the cartridge 100, the toner 120 is able to flow or otherwise move from the reservoir 150 through the outlet opening 130 and to the imaging device 110. In the simplified cross sectional view of the cartridge provided in FIG. 2, one can appreciate that if the flexible tape 180 is removed from the cartridge 100, the toner 120 will be able to move or flow from the reservoir 150 towards an imaging roller 230 to be consumed as images are formed.

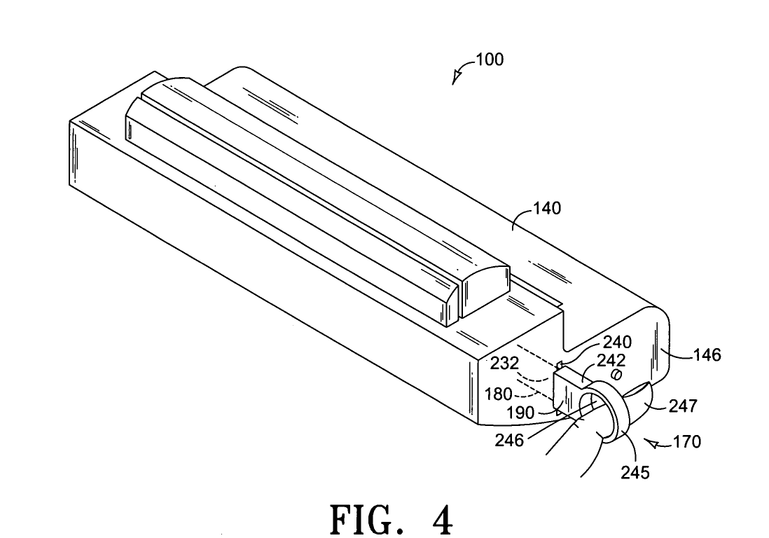

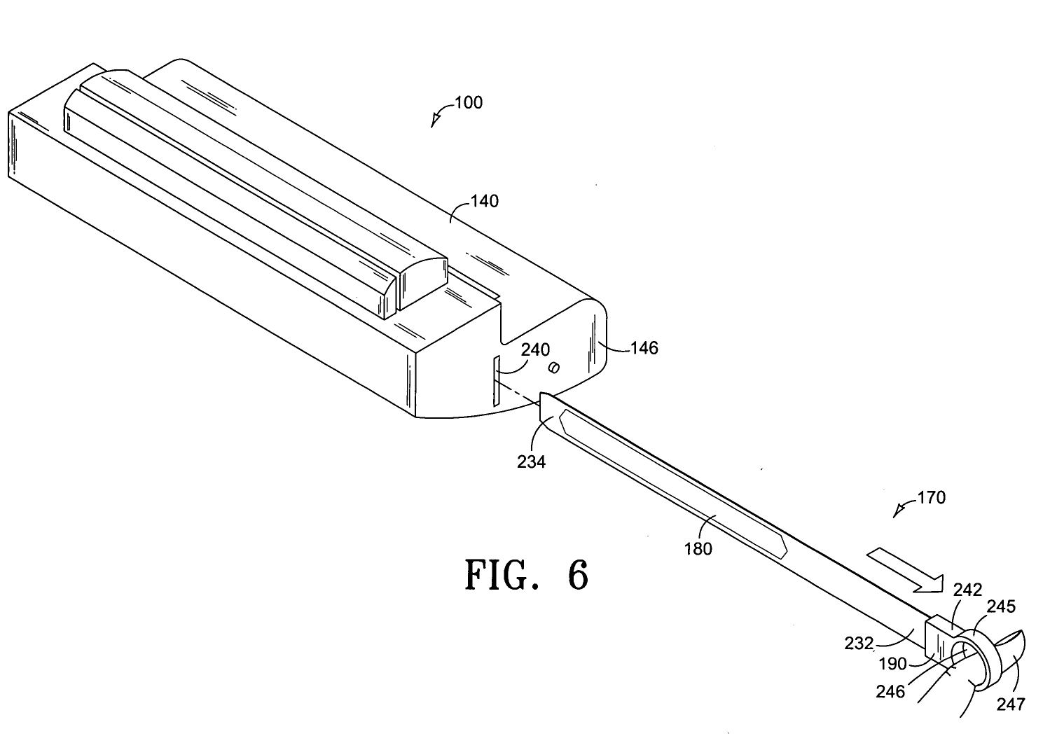

Referring now to FIG. 6, it can be appreciated that the flexible tape 180 is an elongated structure, having a first end 232 and a second end 234. As shown in FIGS. 1 and 4, when the flexible tape 180 is fully coupled to the cartridge 100, the first end 232 of the flexible tape 180 extends from the first side wall 146 of the cartridge housing 140. Thus, in the depicted implementation, the flexible tape 180 includes at least one end (i.e., first end 232) which extends outwardly from the cartridge 100.

FIGS. 1, 3 and 4, show a portion of first end 232 of the flexible tape 180 in phantom lines. These phantom lines indicate the general orientation and position of the flexible tape 180 within the cartridge 100. As shown, the first end 232 of the flexible tape 180 extends outwardly from a seal aperture 240 which is located at the first side wall 146 of the cartridge 100. The pull-ring 190 can be attached to the first end 232 of the flexible tape 180 as described below.

Referring now to FIGS. 1 and 3-6, the pull-ring 190 can be attached to the first end 232 of the flexible tape 180. Moreover, the pull-ring 190 can be attached to the flexible tape 180 in any suitable fashion. However, the pull-ring 190 should be securely attached to the flexible tape 180, so that the pull-ring 190 can be used to remove the flexible tape 180 from the cartridge 100 as described below.

The pull-ring 190 is configured to prevent installation of the cartridge 100 into the imaging device 110 while the seal 180 (e.g., the flexible tape) is coupled to the cartridge 100. The present invention contemplates that the pull-ring 190 can be configured in many different ways to accomplish this purpose, so long as the selected configuration precludes installation of the cartridge 100 until the seal 180 has been removed. In the depicted implementation, the pull-ring 190 protrudes from the cartridge 100 (as shown in FIG. 3) to thereby prevent installation of the cartridge into the imaging device 110 while the flexible tape 180 is coupled to the cartridge 100.

Referring again to FIGS. 1 and 3-6, the pull-ring 190 includes a narrow end 242 which is attached to the flexible tape 180, and a wide end 245 configured to facilitate grasping the pull-ring 190. The pull-ring 190 can be made of any suitable material. However, the material used to form the pull-ring 190 should resist deformation adequately to ensure that the cartridge 100 cannot be installed in the imaging device 110 until the pull-ring 190 and attached seal 180 have been uncoupled from the cartridge 100. In one implementation the pull-ring 190 is made from a rigid material, while in another implementation the pull-ring is made from a substantially non-malleable material. The term “substantially non-malleable material” is used herein to refer to any material which resists deformation adequately to ensure that the cartridge 100 cannot be installed in the imaging device 110 until the pull-ring 190 and attached seal 180 have been uncoupled from the cartridge 100.

The pull-ring 190 can also include a center aperture 246 which is configured to receive a user's finger 247. The user can either insert a finger 247 into the center aperture 246 or simply grasp the pull-ring 190 when preparing to remove the flexible tape 180.

Referring now to FIG. 3, one can appreciate that the configuration of the pull-ring 190 prevents the cartridge 100 from being installed into the imaging device 110 before the flexible tape 180 has been removed. As shown, the pull-ring 190 extends sufficiently outwardly from the cartridge 100, to prevent the cartridge 100 from being inserted into the imaging device 110.

As described above, the present invention contemplates that the pull-ring 190 can comprise various configurations, and the configuration shown in FIGS. 1-6 are but one example. In alternated variations contemplated by the present invention, the pull-ring 190 can comprise any suitable material, can be of any suitable size, and can be any suitable shape, as long as the pull-ring 190 will prevent the cartridge 100 from being received by the imaging device 110 until the seal 180 has been removed.

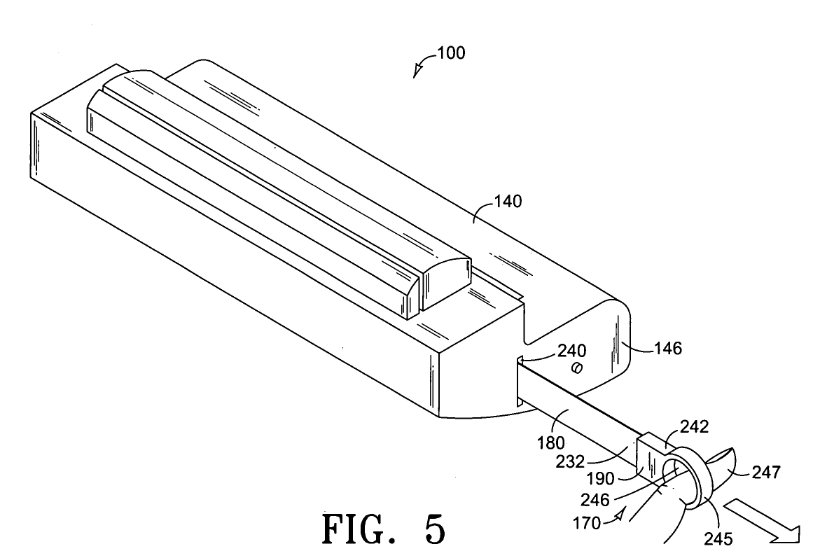

Once the pull-ring 190 has been grasped by the user, the user can easily remove the flexible tape 180 from the cartridge 100 by pulling the pull-ring 190 away from the cartridge 100 as indicated by the arrows shown in FIGS. 5 and 6. The flexible tape 180 is extracted from the seal aperture 240 as it is removed from the cartridge 100. FIG. 5 shows the flexible tape 180 after it has been partially removed from the cartridge 100, while FIG. 6 shows the flexible tape 180 after it has been completely removed or uncoupled from the cartridge 100.

Referring to FIGS. 3, 7 and 8, the imaging device 110 is now further described. The imaging device 110 includes a housing 250. The housing 250 includes a top cover 260 and a top output bin 270. A status panel or control panel 280 can be provided to allow the user to control certain operational aspects of the imaging device 110. A first paper tray door 290 and a second paper tray door 300 are provided, so that the user can load imaging media (e.g., paper) into the imaging device 110.

As shown in FIGS. 3, 7 and 8, the top cover 260 of the imaging device 110 has been opened so that a user can install the cartridge 100 into the imaging device 110. Once the top cover 260 has been opened, one can appreciate that the imaging device 110 includes a designated receptacle 148 which is configured to receive the cartridge 100 containing the toner 120. The receptacle 148 is at least partially defined by a blocking surface 320. In operation, the blocking surface 320 prevents the cartridge 100 from being received by the receptacle 148 until the seal 180 (e.g., the flexible tape), and in particular the pull-ring 190, have been removed from the cartridge 100.

As described above, the cartridge 100 is defined at least in part by the cartridge housing 140 which generally defines the overall shape and size of the cartridge 100. The cartridge housing 140 typically defines a shape which is configured to be received within the designated receptacle 148 within the imaging device 110 (see FIGS. 3, 7 and 8). However, as long as the flexible tape 180 and attached pull-ring 190 have not been uncoupled from the cartridge 100, the pull-ring 190 which protrudes from the first side wall 146 of the cartridge 100 will prevent the cartridge 100 from being installed in the imaging device 110.

For the sake of clarity, the description thus far has emphasized cartridge 100 which is configured to contain toner 120. However, it should be appreciated that cartridge 100 provides just one example of such a cartridge, and the present invention contemplates cartridges of any suitable configuration, shape, or size.

As shown in FIGS. 1, 3 and 4, when the flexible tape 180 is fully coupled to the cartridge 100, the pull-ring 190 extends outwardly from the cartridge housing 140, thereby preventing the cartridge 100 from being received within the designated receptacle 148 of the imaging device 110. In order for the cartridge 100 to be received by the imaging device 110, the flexible tape 180 and the attached pull-ring 190 are to be removed from the cartridge 100 before the cartridge 100 is installed.

As shown best in FIG. 3, if one attempts to insert the cartridge 100 into the designated receptacle 148 of the imaging device 110 before the flexible tape 180 has been uncoupled from the imaging device 110, the pull-ring 190 which protrudes or extends outwardly from the cartridge 100 will contact (i.e., is blocked by) the blocking surface 320 of the imaging device 110, thereby preventing installation of the cartridge 100 into the imaging device 110.

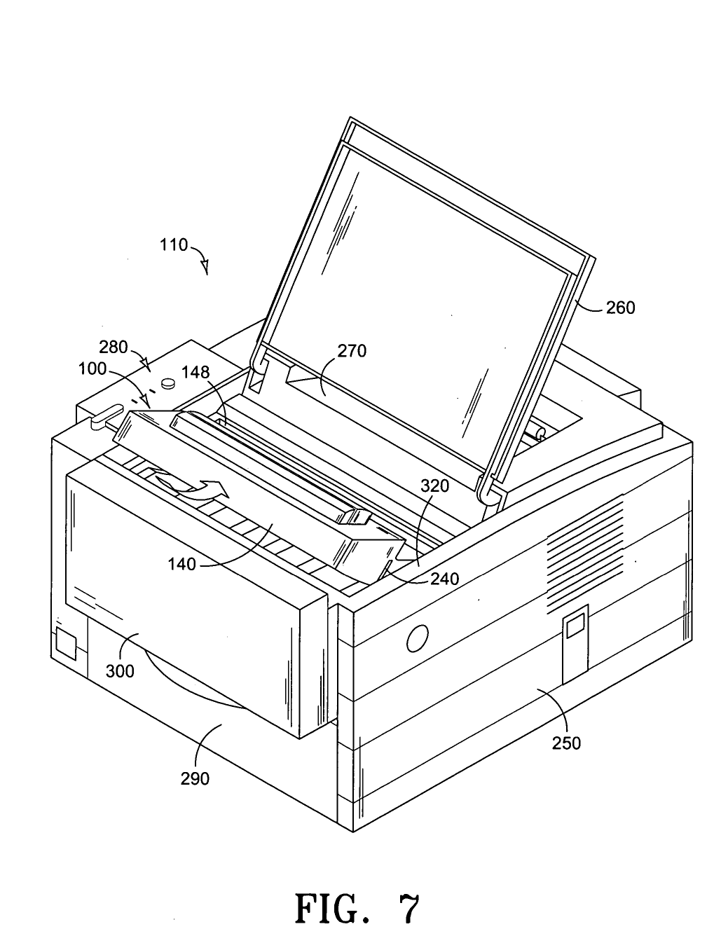

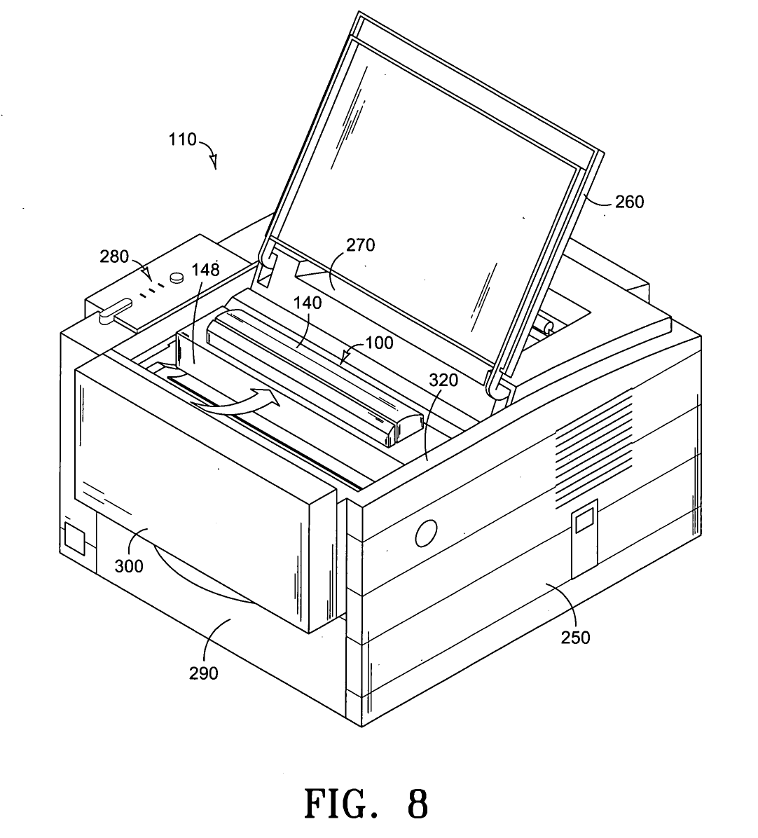

As indicated by the arrows shown in FIGS. 7 and 8, after the flexible tape 180 and attached pull-ring 190 have been removed from the cartridge 100, the cartridge 100 can be easily received by the designated receptacle 148 within the imaging device 110. This is possible because the pull-ring 190 is no longer present to interfere with the insertion of the cartridge 100 into the designated receptacle 148 of the imaging device 110.

Referring generally to FIGS. 1-8, methods of the present invention are now described. In one aspect, the present invention provides a method to ensure that a seal 180 is removed from a cartridge 100 configured to contain toner 120 before the cartridge 100 is installed in an imaging device 110. The method includes providing the cartridge 100 which is defined in part by a cartridge housing 140 which is configured to be received within a designated receptacle 148 within the imaging device 110. The method also includes providing the seal 180, which is releasably coupled to the cartridge 100. The method further includes providing a pull-ring 190 which is attached to the seal 180. As shown, the pull-ring 190 protrudes from the cartridge housing 140 to prevent the cartridge 100 from being received within the designated receptacle 148 until the seal 180 has been uncoupled from the cartridge 100.

In one variation, after providing the seal 180, the method includes uncoupling the seal 180 from the cartridge 100 so that the cartridge 100 can be received within the designated receptacle 148. In another variation, uncoupling the seal 180 includes pulling the pull-ring 190 away from the cartridge 100 as shown in FIGS. 5 and 6.

The operation of the described embodiments of the present invention is believed to be readily apparent and is briefly summarized at this point with general reference once again to FIGS. 1-8. In one aspect, the present invention relates to a cartridge 100 configured to contain toner 120 which is to be consumed by an imaging device 110 via an outlet opening 130 in the cartridge 100. The cartridge 100 includes a reservoir 150 configured to contain the toner 120. The reservoir 150 is coupled in fluid flowing relation to the outlet opening 130. The cartridge includes a removable seal 180 which is configured to be releasably coupled to the cartridge 100, and is further configured to substantially seal the outlet opening 130 while the seal 180 is coupled to the cartridge 100. A pull-ring 190 is attached to the seal 180. The pull-ring 190 is configured to prevent installation of the cartridge 100 into the imaging device 110 while the seal 180 is coupled to the cartridge 100.

In one implementation the pull-ring 190 includes a narrow end 242 attached to the seal 180, and a wide end 245 which is configured to facilitate grasping the pull-ring 190. In another implementation, the pull-ring 190 includes a center aperture 246 configured to receive a user's finger. In one implementation, the pull-ring 190 is made from a rigid material, while in another implementation the pull-ring 190 is made from a substantially non-malleable material. In yet another implementation, the removable seal 180 is provided as a flexible tape. The flexible tape 180 is positioned within a slot 200 inside of the cartridge 100 while the flexible tape 180 is couple to the cartridge 100. In yet another implementation, the pull-ring 190 protrudes from the first side wall 146 of the cartridge 100.

In another aspect the cartridge 100 includes a flexible tape 180 which is releasably coupled to the cartridge 100. The flexible tape 180 is configured to substantially seal the outlet opening 130 while the flexible tape 180 is coupled to the cartridge 100. The flexible tape 180 includes at least one end 232 which extends from the cartridge 100. The cartridge 100 also includes, a pull-ring 190 which is attached to the at least one end 232 of the flexible tape 180 which extends from the cartridge 100. The pull-ring 190 protrudes from the cartridge 100 to prevent installation of the cartridge 100 into the imaging device 110 while the flexible tape 180 is coupled to the cartridge 100.

In another aspect an imaging device 110 is disclosed. The imaging device 110 includes a receptacle 148 configured to receive a cartridge 100 containing toner 120. The receptacle 148 is at least partially defined by a blocking surface 320 which in operation prevents the cartridge 100 from being received by the receptacle 148 until a pull-ring 190 attached to a flexible tape 180 has been removed from the cartridge 100.

In another aspect a method which ensures that a seal 180 is removed from a cartridge 100 configured to contain toner 120 before the cartridge 100 is installed in an imaging device 110 is described. The method includes providing the cartridge 100. The cartridge 100 is defined in part by a cartridge housing 140 configured to be received within a designated receptacle 148 within the imaging device 110. The method also includes providing the seal 180, which is releasably coupled to the cartridge 100. The method further includes providing a pull-ring 190 which is attached to the seal 180. The pull-ring 190 protrudes from the cartridge housing 140 to prevent the cartridge 100 from being received within the designated receptacle 148 until the seal 180 has been uncoupled from the cartridge 100

In one implementation, after providing the seal 180, the method further includes uncoupling the seal 180 from the cartridge 100 so that the cartridge 100 can be received within the designated receptacle 148. In another implementation, the uncoupling the seal 180 from the cartridge 100 the method includes pulling the pull-ring 190 away from the cartridge 100.

In yet another aspect, a cartridge 100 is described. The cartridge 100 is configured to contain toner 120 which is to be consumed by an imaging device 110 via an outlet opening 130 in the cartridge 100. The cartridge 100 includes means for releasably sealing the outlet opening 130 to substantially prevent movement of the toner 120 from the cartridge 100 to the imaging device 110. The cartridge 100 also includes means for preventing installation of the cartridge 100 into the imaging device 110 when the outlet opening 130 is sealed. In one implementation, the means for releasably sealing the outlet opening 130 include a flexible tape 180. In another implementation, the means for preventing installation of the cartridge 100 into the imaging device 110 includes a pull-ring 190. The pull-ring 190 is attached to the means for releasably sealing the outlet opening 130 and protrudes from the cartridge 100.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the Doctrine of Equivalents.

1. A cartridge configured to contain toner which is to be consumed by an imaging device via an outlet opening in the cartridge, the cartridge comprising:
a reservoir configured to contain the toner, wherein the reservoir is coupled in fluid flowing relation to the outlet opening;
a removable seal releasably coupled to the cartridge, and configured to substantially seal the outlet opening while the seal is coupled to the cartridge; and
a pull-ring attached to the seal, wherein the pull-ring is configured to prevent installation of the cartridge into the imaging device while the seal is coupled to the cartridge.

2. The cartridge of claim 1, wherein the pull-ring comprises:
a narrow end attached to the seal; and
a wide end configured to facilitate grasping the pull-ring.

3. The cartridge of claim 1, wherein the pull-ring comprises:
a center aperture configured to receive a user's finger.

4. The cartridge of claim 1, wherein the pull-ring comprises:
a rigid material.

5. The cartridge of claim 1, wherein the pull-ring comprises:
a substantially non-malleable material.

6. The cartridge of claim 1, wherein the removable seal comprises a flexible tape, and wherein the flexible tape is positioned within a slot inside of the cartridge while the flexible tape is couple to the cartridge.

7. The cartridge of claim 1, wherein the pull-ring protrudes from a side of the cartridge.

8. A cartridge configured to contain toner which is to be consumed by an imaging device via an outlet opening in the cartridge, the cartridge comprising:
a reservoir configured to contain the toner, wherein the reservoir is coupled in fluid flowing relation to the outlet opening; and
a flexible tape releasably coupled to the cartridge, wherein the flexible tape is configured to substantially seal the outlet opening while the flexible tape is coupled to the cartridge, and wherein the flexible tape includes at least one end which extends from the cartridge; and
a pull-ring attached to the at least one end of the flexible tape which extends from the cartridge, wherein the pull-ring protrudes from the cartridge to prevent installation of the cartridge into the imaging device while the flexible tape is coupled to the cartridge.

9. The cartridge of claim 8, wherein the pull-ring comprises:
a narrow end attached to the flexible tape; and
a wide end configured to facilitate grasping the pull-ring.

10. The cartridge of claim 8, wherein the pull-ring comprises:
a center aperture configured to receive a user's finger.

11. The cartridge of claim 8, wherein the pull-ring comprises:
a rigid material.

12. The cartridge of claim 8, wherein the pull-ring comprises:
a substantially non-malleable material.

13. The cartridge of claim 8, wherein the flexible tape is configured to be positioned within a slot inside of the cartridge while the flexible tape is couple to the cartridge.

14. An imaging device comprising a receptacle configured to receive a cartridge containing toner, the receptacle being at least partially defined by a blocking surface which in operation prevents the cartridge from being received by the receptacle until a pull-ring attached to a flexible tape has been removed from the cartridge.

15. A method to ensure that a seal is removed from a cartridge configured to contain toner before the cartridge is installed in an imaging device, the method comprising:
providing the cartridge, wherein the cartridge is defined in part by a cartridge housing configured to be received within a designated receptacle within the imaging device;
providing the seal, wherein the seal is releasably coupled to the cartridge; and
providing a pull-ring attached to the seal, wherein the pull-ring protrudes from the cartridge housing to prevent the cartridge from being received within the designated receptacle until the seal has been uncoupled from the cartridge.

16. The method of claim 15, wherein after providing the seal, the method further comprises:
uncoupling the seal from the cartridge so that the cartridge can be received within the designated receptacle.

17. The method of claim 16, wherein the uncoupling the seal from the cartridge further comprises:
pulling the pull-ring away from the cartridge.

18. A cartridge configured to contain toner which is to be consumed by an imaging device via an outlet opening in the cartridge, the cartridge comprising:
means for releasably sealing the outlet opening to substantially prevent movement of the toner from the cartridge to the imaging device; and
means for preventing installation of the cartridge into the imaging device when the outlet opening is sealed.

19. The cartridge of claim 18, wherein the means for releasably sealing the outlet opening comprises a flexible tape.

20. The cartridge of claim 18, wherein the means for preventing installation of the cartridge into the imaging device comprises a pull-ring which is attached to the means for releasably sealing the outlet opening, and wherein the pull-ring protrudes from the cartridge.
